(19) United States
(12) Patent Application Publication
(10) Pub. No.: US 2026/0178859 A1
(43) Pub. Date: Jun. 25, 2026

(54) SECURITY DOCUMENT COMPRISING A SUBPIXEL PATTERN

(71) Applicant: IDEMIA Identity & Security France, Courbevoie (FR)

(72) Inventor: Benoît BERTHE, Courbevoie (FR)

(73) Assignee: IDEMIA Identity & Security France, Courbevoie (FR)

(21) Appl. No.: 19/125,156

(22) PCT Filed: Oct. 16, 2023
(86) PCT No.: PCT/EP2023/078681

§ 371 Date: Apr. 28, 2025

(30) Foreign Application Priority Data
Nov. 15, 2022 (FR) FR2211870

(51) Int. Cl. G06K 7/10; G06K 7/14; G06K 19/06

(52) U.S. Cl. CPC G06K 7/10722; G06K 7/10732; G06K 7/1417; G06K 19/06037

(57) ABSTRACT

A security document is provided that includes a basic pattern of a graphic code comprising graphic code elements that each comprise one or more subpixels, each subpixel being capable of producing a diffractive effect of a colour specific to the subpixel when the subpixel is observed from a given observation position and for a given illumination, a positioning mark for positioning the graphic code comprising a region capable of producing a diffractive effect of a colour specific to the region when it is observed from the same given position.

### TECHNICAL FIELD

The invention relates to the field of graphic codes in which information may be coded and which are observable in security documents.

### PRIOR ART

As known (one-dimensional) barcodes are graphic codes taking the form of a series of bars and spaces, the respective thickness of which varies as a function of the data being coded. A barcode is formed on a medium, generally via a printing process, and allows information to be coded in a relatively compact manner.

Barcodes are intended to be read by a barcode reader equipped with an optical sensor. The data coded in a barcode may thus be acquired automatically using a barcode reader.

More recently, a new type of barcode-called a two-dimensional barcode or 2D barcode—has been developed. A two-dimensional barcode is a graphic code or pictogram, made up of small squares and of white areas. It is a question of a two-dimensional format of the one-dimensional barcode, thus allowing a greater concentration of information in a given space. As with a one-dimensional barcode, the content of a 2D barcode (sometimes also referred to as a QR code, QR being the abbreviation of Quick Response) is rapidly readable by means of a suitable barcode reader.

Generally, barcodes and other equivalent pictograms are 2D graphic codes, i.e. graphic codes formed on a medium in 2 dimensions and configured to code or represent a greater or lesser amount of information.

For example, barcodes are at the present time widely used to identify items in stores around the world. 2D barcodes (QR codes) have also been increasingly used in recent years, for example to identify a web page or an application, or to code a fare or a ticket giving access to a given service. 2D barcodes are advantageous in that they may be recognized automatically by an application executed on a terminal (smartphone, tablet, webcam, etc.) equipped with a camera.

The use of barcodes, and more generally of 2D graphic codes, further has the advantage of securing their content, insofar as it may be relatively difficult to read, copy and/or falsify such codes, at least without access to suitable hardware and expertise. Various cryptographic techniques allow the security of these codes to be considerably increased. In particular, 2D graphic codes may be affixed in various forms to official documents, such as identity documents for example (identity cards, passports, etc.), in order to allow them to be authenticated securely.

In certain situations, a conventional 2D graphic code (such as one of those described above) does not provide enough capacity to store all the necessary information. For example, when it is a question of storing the biometric fingerprint of the portrait featuring on an identity document, the area required for a 2D barcode becomes prohibitive with respect to the area available on the document and the other information that must also appear on the document.

Typically, an image of a face may only be stored by a 2D graphic code occupying an area of one square inch if it is compressed to a level making it impossible to use the image to identify a person with certainty (file size on the order of 1 kilobyte). An image of acceptable quality, for example stored in a file of 3 kilobytes, would occupy, for example with graphic codes of the prior art (black and white graphic codes, for example), an area of about 3 square inches, this being unacceptable for identity documents the dimensions of which are constrained, for example by the standard ISO 7810.

Storage in coded form of an image nevertheless remains very sought after, since it would make it possible to obtain a digital form of the image, the display of which on a display screen would always be of good quality. Images printed on documents for example have the drawback of sometimes being difficult to observe, for example because of lighting-induced reflections, of scratches altering the surface of the image, or even of other unwanted optical effects for example created by diffractive patches present to protect the image against counterfeiting.

It is conceivable to print graphic codes the elements of which are colored to code, by means of a plurality of colors, more information per unit area. However, producing graphic codes the colors of which code information remains very difficult.

In fact, it is critical for the printing devices employed to be correctly calibrated for the detection of the colors to be exact enough to distinguish code elements with the right color. Furthermore, a code printed with an ordinary printer will be easily reproduced.

There is currently a need for a new graphic code offering a higher density compared to conventional 2D graphic codes, i.e. having a greater information-storage capacity per unit area, while being very difficult to reproduce and/or clone.

### SUMMARY OF THE INVENTION

The invention provides a security document comprising:
a basic pattern of a graphic code comprising graphic-code elements each having one or more subpixels, each subpixel being capable of producing a diffractive effect of a color specific to the subpixel when the subpixel is observed from a given observation position and under given lighting, and
a mark for positioning the graphic code comprising a region capable of producing a diffractive effect of a color specific to the region when it is observed from the same given position and under the given lighting (the region may have, in an embodiment that is simpler to produce, the same diffractive properties as at least one of the subpixels, or different diffractive properties in an embodiment that is more complex to produce).

The given observation position is for example the same for all the subpixels of the basic pattern. This observation position may be an area in space in which the colors observed are substantially constant and as expected. Here it is accompanied by given lighting.

The given position is a position relative to that of the document, and such is also the case for the given lighting. For example, the given position is substantially constant in the frame of reference of the document (so that the color effect is substantially constant for the given lighting).

This given position is associated with given lighting, for example ambient lighting of a given value or the flash of a smartphone (for example the given lighting may be a position of a light source relative to the position of the document, a light intensity, a form of light beam, etc.).

It is known to use subpixels that produce diffractive effects in security documents. These subpixels may comprise a reflective metal region with a diffractive texture chosen so that the color specific to the subpixel is observed, and they may be arranged on top of an opaque layer, for example an opaque layer of black appearance. Particularly precise techniques may be used to obtain these textures, so that there is no discernible dispersion between the textures of documents intended to be identical but manufactured in different batches. Typically, it is possible to use a basic matrix, which acts as a mold for stamping of the diffractive texture of all the documents to be used. This basic matrix may be manufactured using techniques from the field of microelectronics, laser ablation and electroplating.

The subpixels may be analogous to those described in document FR 3 093 302 or even analogous to those of document FR 3 103 736.

The colors of the subpixels, for the same given positions, under the same given lighting, do not exhibit any perceptible variation between different documents, this making use of these subpixels in a graphic code robust. Specifically, their colors are well calibrated.

The graphic code may be a barcode type or even two-dimensional (a QR code for example). The basic graphic-code building block has a base from which various graphic codes in which various data are coded may be formed. Here, the use of diffractive subpixels makes it possible to use the color of the subpixels as coding information. This allows the density of data stored per unit area to be increased, for example by using multiple colors.

For a code of low content, the code element may be a bar (analogously to what is used for a barcode). For a code of greater content, it is preferably two-dimensional, the code element may then be a unit square (analogously to what is used for a QR code).

The positioning mark comprises a region that produces a diffractive effect, and which may therefore be of the same nature as one of the subpixels described above or indeed different. This region may be manufactured simultaneously with the subpixels of the code elements. They therefore have the same stability in terms of color as the subpixels of the code elements. It is possible to use a positioning mark having a given shape, in order to allow automatic detection of the positioning mark.

For example, the color specific to the region of the positioning mark will be expected (it could be called the expected color, i.e. a pre-recorded color or a combination of a number of pre-recorded colors) to indicate that the document is being observed in the given observation position under given lighting. Furthermore, if the positioning mark is indeed detected with the expected color in the region, it means that all the code elements of the basic graphic-code pattern are being observed in the given observation position, and that they will produce the colors that are specific to each subpixel in the graphic-code elements.

To guarantee that all the code elements of the basic graphic-code pattern are observed in the given observation position, and that they will produce the colors that are specific to each subpixel in the graphic-code elements, it will be preferable for there to be at least 3 or even 4 positioning marks.

Thus, for example, the positioning marks may be on the periphery of the code, for example in 3 or 4 of the 4 corners of the code if it has a square/rectangular shape.

The use of subpixels producing a diffractive effect is also advantageous in that it makes fraudulent reproduction of a security document particularly difficult. Specifically, it is important for security that a fraudster cannot easily produce a duplicate of an authentic identity document. The basic code pattern described here (and more precisely the graphic code it makes possible to form) may act as a container for confidential data just like chips do currently, and as such many checks may be carried out merely by reading the code (or more precisely the graphic code), just as in the case of chips, and it is therefore very advantageous for this code not to be easily clonable.

According to one particular embodiment, the region of the positioning mark is capable of producing a diffractive effect of the same color as a subpixel of the basic graphic-code pattern from the same given observation position.

This embodiment makes it easier to determine the component associated with this color for the code element, since the positioning mark also exhibits this color. Thus, this embodiment makes it possible to implement a calibration for read-out of the colors in the code elements. Furthermore, this embodiment is simpler to produce than a variant in which another color is used in this region.

In fact, when a camera observes the region of the positioning mark with its expected color, it indicates that subpixels that produce a diffractive effect of the same color will necessarily be producing this effect of the same color. Consequently, the colorimetric information of the code elements may be read correctly at least for this color (this amounts to a calibration).

According to one particular embodiment, the document comprises one or more perforations of one or more subpixels of a graphic-code element so that the graphic-code element is capable of producing a diffractive effect of a color specific to the graphic-code element when the graphic-code element is observed from the given observation position, the color specific to the graphic-code element resulting from the diffractive effects of the subpixels of the graphic-code element and from the presence of the one or more perforations.

These perforations may be complete (they completely replace a subpixel) or partial (a portion of the area of a subpixel is perforated). Those skilled in the art are familiar with diffractive layers and thin metal reflective layers that are easily perforable, for example by applying a laser beam to a reflective layer of vacuum-deposited aluminum.

A perforation affects the color that is observed for a code element. In fact, provided that the subpixels are small enough, the colors of each of the subpixels of a code element are able to mix, i.e. integrate within the sensor of a camera used for read-out, so that only one color or shade is observed for the code element. Of course, this mixing is a result not only of the size of the subpixels but also of the resolution of the devices used to observe the documents (cameras for example).

By way of indication, the subpixels of the code may be dimensioned in such a way that, for a camera having a given resolution, a camera pixel encompasses at least two subpixels of the security document (preferably, the subpixels all have the same size). Even more advantageously, if a code element comprises a plurality of pixels, each comprising a given number of subpixels, the subpixels may be dimensioned so that a camera pixel encompasses at least two pixels of the security document (such will be the case for pixels with red-green-blue subpixels).

According to one particular embodiment, data are coded in the graphic code formed by the basic pattern of the graphic code comprising one or more perforations, the coding of the data taking into account the color specific to each graphic-code element.

In this particular embodiment, rather than a simple basic graphic-code building block a graphic code in which data have been coded by means of perforations that affect the color of the code elements is employed.

The coding may use an alphabet system that associates symbols of the data (for example binary strings) with colors. Lookup tables may be used, or even coding functions that deliver colors for data. The colors are further associated with perforations, i.e. perforation sizes and positions, so that a desired color is indeed observed for a code element.

According to one particular embodiment, the pattern comprises another basic pattern of a graphic code,
the other basic pattern of a graphic code comprising graphic-code elements each having one or more subpixels, each subpixel being capable of producing a diffractive effect of a color specific to the subpixel when the subpixel is observed from another given observation position that differs from the given observation position (the lighting may be the same, the given lighting (in particular it is a question of ambient lighting), or different), and
another graphic-code positioning mark comprising a region capable of producing a diffractive effect of a color specific to the region when it is observed from the other given position,
the document further comprising a lens array the lenses of which are arranged so that, in the given observation position, light is focused on the subpixels of the basic graphic-code pattern, and in the other given observation position, light is focused on the subpixels of the other basic graphic-code pattern (or on the subpixels of the graphic codes if perforations have been formed),
said basic graphic-code pattern and the other basic graphic-code pattern being interleaved.

This interleaving may be achieved by alternating the code elements of the basic pattern and the code elements of the other basic pattern. For example, this alternation may occur in a direction in the plane of the graphic code.

By including two graphic codes, the amount of information codable or coded in the document is increased. Furthermore, fraudulent reproduction of the graphic codes is made more complicated.

According to one particular embodiment, the subpixels of the basic graphic-code pattern and the subpixels of the other basic graphic-code pattern capable of producing a diffractive effect of the same color are arranged in parallel rows in which the subpixels of the basic graphic-code pattern and the subpixels of the other basic graphic-code pattern alternate, and the lens array comprises lenses extending in a direction perpendicular to those of the rows of subpixels.

In this particular embodiment, the lenses for example form a lenticular array. Here, a rotation of the device may lead to the lenses focusing on subpixels of the same type (same effect color) but belonging to one or other of the patterns. If graphic codes are formed, various codes may be observed by making an observation angle vary.

According to one particular embodiment, the area of the region of the positioning mark is larger than the area of each pixel of the basic graphic-code pattern, for example 10 times larger.

This particular embodiment makes it easier to detect the color of the region of the positioning mark, which may be used both to determine the position of the graphic-code elements but also to calibrate detection of the colors of the code elements. Thus, and as explained above, once this color is observed, the document is necessarily being observed from the given observation position. Therefore, the subpixels that have the same color as the region, if any, produce the same color via a diffractive effect and their contribution in the code elements is then assessed, for example measured, precisely. In fact, this facilitates calibration of the read-out.

According to one particular embodiment, the mark for positioning the graphic code comprises a plurality of regions, each region being capable of producing a diffractive effect of a color specific to the region when it is observed from the same given position, the colors of the diffractive effects of each region being different and forming a color base.

This particular embodiment is very advantageous because it makes it possible to calibrate a device that will read the graphic code and decode the information taking colors into account.

In this embodiment, there may be pixels producing the same color as these regions in the basic graphic-code pattern.

For example, the color base may be a red-green-blue base, or a yellow-cyan-magenta base. It is possible to use a mark the shape of which is automatically detectable, in order then to obtain the colorimetric values observed in each region, this then allowing a calibration applicable to read-out of all the code elements to be carried out.

The subpixels of the basic pattern of the graphic code may also (all) be subpixels of a color base (preferably the same as that of the positioning mark). If the base is a base of C colors (for example C=3 for red-green-blue), in a code element there are one or more groups of C subpixels respectively associated with red, green and blue (the color of their diffractive effect in the given observation position). Preferably, there are a plurality of groups of C subpixels in a graphic-code element.

According to one particular embodiment, each region of the positioning mark is capable of producing a diffractive effect of the same color as a subpixel of the basic graphic-code pattern from the same given observation position.

In fact, this embodiment is an embodiment in which once the colors expected for the regions are observed, for example by a camera, then subpixels will produce the diffractive effects of the same colors. This means that during read-out (in an image acquired by the camera), the colorimetric contribution of each subpixel in the graphic-code elements will be able to be measured accurately. For example, exactly the blue component, the green component, and the red component is obtained for each graphic-code element once the colors red, green, and blue have been observed in a positioning mark: this ensures the correctness of the read-out of the code that may follow.

The invention also provides a process for manufacturing a security document, wherein a basic pattern of a graphic code comprising graphic-code elements each having one or more subpixels is formed, each subpixel being capable of producing a diffractive effect of a color specific to the subpixel when the subpixel is observed from a given observation position and under given lighting, and
a mark for positioning the graphic code is formed, the positioning mark comprising a region capable of producing a diffractive effect of a color specific to the region when it is observed from the same given position and under given lighting.

This process may be configured to manufacture documents according to all the embodiments described above.

The subpixels of the basic pattern and the subpixels of the positioning mark may be formed simultaneously, for example in the same step of forming a diffractive layer applied to a reflective layer (for example a metal reflective layer, for example an aluminum reflective layer) using a single mold defining textures for each subpixel. This diffractive layer may be joined to other layers to form the security document, for example by rolling.

According to a particular mode of implementation, one or more subpixels of a graphic-code element are perforated so that the graphic-code element is capable of producing a diffractive effect of a color specific to the graphic-code element when the graphic-code element is observed from the given observation position, the color specific to the graphic-code element resulting from the diffractive effects of the subpixels of the graphic-code element and from the presence of the one or more perforations.

According to one particular mode of implementation, the process comprises obtaining data beforehand, and
coding the obtained data so as to deliver at least the positions of the one or more perforations prior to their perforation, so that the data are coded in the graphic code formed by the basic pattern of the graphic code comprising the one or more perforations, the coding of the data taking into account the color specific to each graphic-code element.

According to a particular mode of implementation, another basic pattern of a graphic code is formed,
the other basic pattern of a graphic code comprising graphic-code elements each having one or more subpixels, each subpixel being capable of producing a diffractive effect of a color specific to the subpixel when the subpixel is observed from another given observation position that differs from the given observation position, and
another graphic-code positioning mark is formed, the graphic-code positioning mark comprising a region capable of producing a diffractive effect of a color specific to the region when it is observed from the other given position,
the process further comprising forming a lens array the lenses of which are arranged so that, in the given observation position, light is focused on the subpixels of the basic graphic-code pattern, and in the other given observation position, light is focused on the subpixels of the other basic graphic-code pattern,
said basic graphic-code pattern and the other basic graphic-code pattern being interleaved.

According to one particular mode of implementation, the subpixels of the basic graphic-code pattern and the subpixels of the other basic graphic-code pattern capable of producing a diffractive effect of the same color are arranged in parallel rows in which the subpixels of the basic graphic-code pattern and the subpixels of the other basic graphic-code pattern alternate, and the lens array comprises lenses extending in a direction perpendicular to those of the rows of subpixels.

The invention also provides a method for reading information coded by a document such as defined above, wherein the document is observed in the given observation position, the positioning mark is detected, and the information is decoded taking into account the colors observed in the graphic-code elements.

This method may be implemented automatically, for example by means of a camera that observes the document and of a computer system that may detect the positioning mark in an image acquired during observation of the document. The computer system may further decode the information.

Detection of the positioning mark comprises detection of at least the shape of the positioning mark (this detection may deliver its position in an image of the document acquired during observation). The positioning mark may also be detected by detecting one or more colors expected for the positioning mark.

In this embodiment, detection of the positioning mark may comprise detection of the diffractive effect of the region with the expected color, which indicates that the document is being observed in the given observation position and that the subpixels of the code elements will be producing the right diffractive effect with the right color.

According to one particular mode of implementation, a sequence of images of the document presented at various observation angles is obtained, and the image in which a region of the positioning mark has an expected color (for example the color specific to the region visible in the given observation position) is selected from the sequence of obtained images, the selected image being an image in which the document is observed in the given observation position.

In fact, it is because the region with the expected color has been observed that it is known that the document may be read, the document necessarily being observed in the given observation position. Consequently, the subpixels of the code elements will be producing diffractive effects with the right colors, and it is possible to read the code correctly.

When the positioning marks comprise a plurality of regions the colors of which form a color base, and optionally when there are subpixels producing diffractive effects with the colors of the color base, then detection of the expected colors of each region makes it possible to ensure that, for each graphic-code element, the component of each color of the base is correctly measured.

For a red-green-blue color base, a three-region positioning mark is used, and once the mark is detected with these red-green-blue colors, the red-green-blue components of each graphic-code element are correct and allow the graphic code to be read.

According to one particular mode of implementation, the method comprises detecting at least one image of the image sequence in which a region of the positioning mark has a color other than the expected color, with a view to deducing an authentication of the document therefrom.

For example, the positioning mark may be detected based on its shape and a color that is not the expected color may be observed therein. This means that various observation angles lead to variations in color, and that the document indeed contains diffractive elements (it is not a copy printed with the expected colors).

More precisely, by virtue of the image sequences preceding or following the image selected as being the one in which the colors are correctly calibrated, it is possible, for example via automatic processing, to verify that the colors of the preceding and following sequences conform with the colors that the diffractive elements should produce if they are authentic elements. For example, if the observation angle is larger than that of the position in which the colors are calibrated (the region has the expected color, or the regions have the expected colors), the wavelength of the diffracted colors will be longer, more toward the reds, whereas if it is smaller, the diffracted wavelengths will be shorter and therefore more toward the blue. These properties may therefore be verified in passing and thus make it possible to authenticate whether it is indeed a question of a diffractive matrix that has the characteristics of an original matrix and that is therefore very difficult to clone. Thus, the method of this mode of implementation not only allows a large amount of data coded in a small area to be read out reliably, but also ensures that it is neither a question of a copy nor of a fake created from scratch.

According to one particular mode of implementation, the document is a document such as defined above in which information is coded and in which the positioning mark comprises a plurality of regions, the method comprising a calibration phase in which the observed colors of the regions of the positioning mark are taken into account.

The invention also provides a system for reading information coded by a document such as defined above, comprising a module for observing the document in the given observation position (typically a camera), a module for detecting the positioning mark (detection of its position, of its shape, and possibly of its one or more colors), and a module for decoding the information taking into account the colors observed in the graphic-code elements (typically a computer system).

According to one particular embodiment, the system (for example the computer system of the system) is configured to obtain a sequence of images of the document presented at various observation angles, and to select, from the sequence of obtained images, the image in which a region of the positioning mark has an expected color (for example the color specific to the region visible in the given observation position), the selected image being an image in which the document is observed in the given observation position.

According to one particular mode of implementation, the system is configured to detect at least one image of the image sequence in which a region of the positioning mark has a color other than the expected color, with a view to deducing an authentication of the document therefrom.

### BRIEF DESCRIPTION OF THE DRAWINGS

Other features and advantages of the present invention will become apparent from the description given below, with reference to the appended drawings, which illustrate exemplary embodiments thereof that are completely non-limiting in nature. In the figures:

FIG. 1 is a front view of a document, according to one example,

FIG. 2 is a cross-sectional view of the document of FIG. 1,

FIG. 3 shows in more detail the basic graphic-code pattern of the document of FIG. 1,

FIG. 4 is a front view of the document of FIG. 1 after personalization, perforation for example,

FIG. 5 is a cross-sectional view of the document of FIG. 4,

FIG. 6 shows in more detail the graphic code of the document of FIG. 4,

FIG. 7 shows a system for reading a document according to one example,

FIG. 8 shows the same colored graphic code at various angles,

FIG. 9 shows the interleaving of two graphic codes,

FIG. 10 again shows the subpixels of the graphic codes of FIG. 9.

### DESCRIPTION OF EMBODIMENTS

Security documents comprising basic graphic-code patterns formed by diffractive subpixels, and also security documents comprising graphic codes coding information, will now be described.

The security documents described in the present description may be documents specific to one user. For example, these documents may be identity documents such as a passport, an identity card, a driver's license, etc.

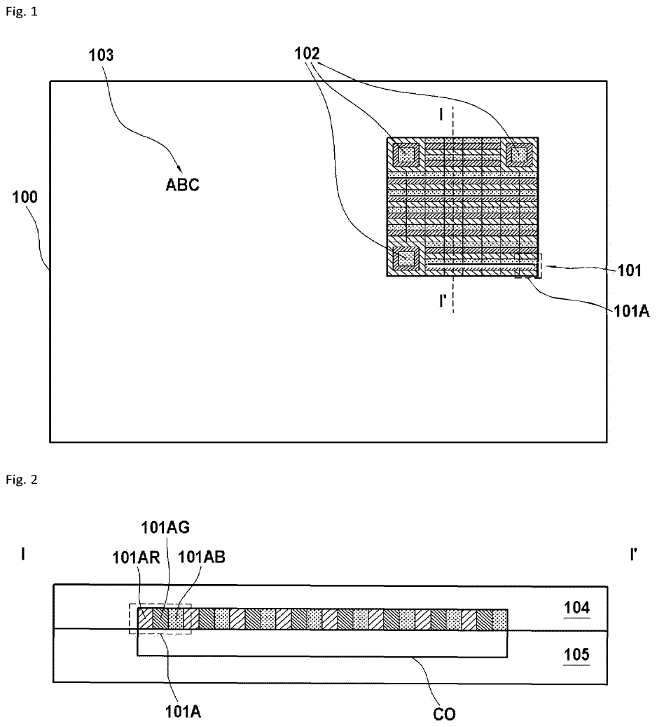

FIG. 1 shows a front view of a security document 100 comprising a basic pattern 101 of a graphic code.

This basic graphic-code building block is here a structure which will subsequently make it possible to obtain a graphic code having a structure analogous to that of known graphic codes except in that the graphic-code elements will be colored (there are not merely two possible shades as is the case with black-and-white graphic codes).

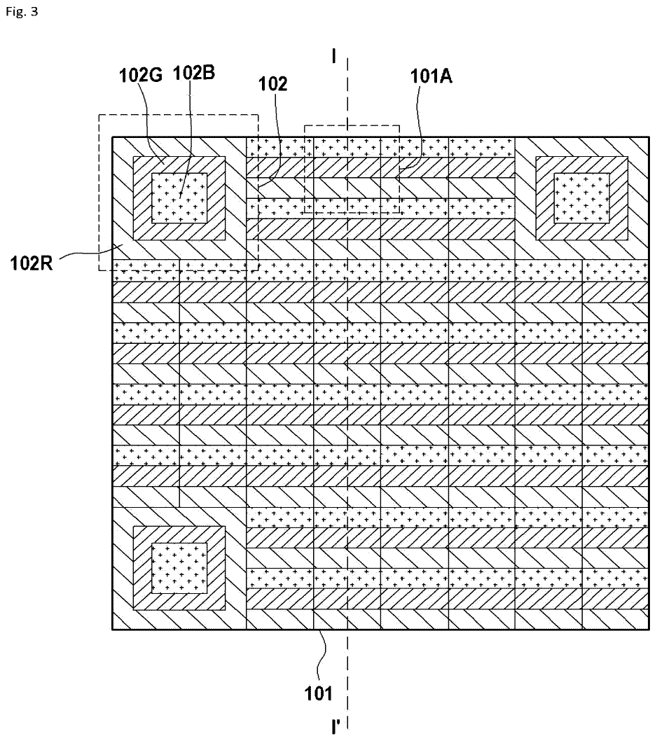

To this end the basic pattern comprises graphic-code elements 101A that will be described in greater detail with reference to FIGS. 2 and 3, with their structure comprising subpixels. These graphic-code elements are arranged as the unit squares of a QR code (registered trademark), although their internal structure differs from those of a QR code. The invention is in no way limited to codes having an arrangement analogous to a QR code and applies, for example, to any graphic code comprising code elements that conventionally appear in two shades (a light shade and a dark shade for example).

In the example illustrated, in addition to the graphic-code elements 101A, marks for positioning the graphic code 102 are also provided, which marks also comprise subpixels that will be described in greater detail with reference to FIGS. 2 and 3. These positioning marks advantageously replace those used to detect and position the code elements of a QR code.

It will be noted that, generally, the basic graphic-code patterns (or graphic codes) referred to here are accompanied by positioning marks visible on the same face of the document as the basic graphic-code patterns (or the graphic codes).

The document 101 also comprises printed information 103.

FIG. 2 is a cross-sectional view of the safety document 100 of FIG. 1, the cross section being cut along the axis I-I′ shown in FIG. 1.

This cross-sectional view shows a plurality of code elements 101A, which each comprise three subpixels. All the code elements 101A are here identical and comprise:
a subpixel called the “red” subpixel 101AR,
a subpixel called the “green” subpixel 101AV,
a subpixel called the “blue” subpixel 101AB.

Each of these subpixels is capable of producing a diffractive effect of the color giving the subpixel its name when the subpixel is observed from a given observation position under given lighting. Consequently, as will be understood, a color base is obtained (here red-green-blue) with each graphic-code element, based on which various colors will be able to be formed.

The subpixels are preferably formed on top of a layer CO that is opaque, and preferably black, and that is analogous to the opaque layer described in French patent application FR 3103736, the content of which is incorporated by reference into the present patent application. In fact, the subpixels may have a structure similar to the structure described in French patent application FR 3103736.

Thus, the subpixels may comprise several layers, a reflective layer, and a carrier layer, just like the subpixels described in the document FR 3103736.

Of course, a code element may comprise a higher number of subpixels, for example multiple groups of three red-green-blue subpixels. For reasons of simplicity, only three subpixels have been shown here.

The subpixels may have been formed from a layer that is textured, so as to be diffractive, and a (metal for example) layer that is reflective, so as to increase the intensity of the colored diffractive effect, on top of a layer that is opaque, black for example. For example, a textured surface will potentially be used to replicate its texture and thus form the diffractive surface. The diffractive surface thus obtained makes it possible to obtain a plurality of documents with all-identical subpixels, which will produce exactly the same colored effects.

The diffractive layer is textured to form the subpixels and may be joined to layers of the document 100, here an upper layer 104, which may be transparent so that the subpixels may be observed, and a lower layer 105. The layers 104 and 105 may be made of polymers, of polycarbonate for example.

FIG. 3, which is a front view, shows the basic graphic-code pattern 101 in more detail. In this figure, the repetition of the graphic-code elements 101A may be seen. One example of positioning marks 102 may also be seen in greater detail.

The positioning marks 102 are here three in number (analogously to the number used in a QR code). It is also possible to have 4 thereof in order to completely frame the area of the code 101. Here, each positioning mark comprises three regions:
a region called the “red” region 102R,
a region called the “green” region 102G,
a region called the “blue” region 102B.

The blue region 102B is square in shape, the green region 102G is arranged around the blue region, and the red region 102R is arranged around the green region.

The regions each comprise a textured surface having the same structure as the subpixels of a graphic-code element 102 described above. Each region is capable of producing a diffractive effect of the color giving the region its name when it is observed from a given observation position.

It will be noted that the shape of the positioning marks allows their detection, analogously to the positioning marks used in a QR code, and that here it is further possible to take into account the red-green-blue colors that will appear. Thus, as will be understood, detection of the three colors of the positioning mark makes it possible to determine that the document is indeed in the given observation position. If red, green and blue are able to be detected in a pattern having the shape of the positioning mark it is proof that at least one basic graphic-code building block (or even a graphic code) is being observed in the given position.

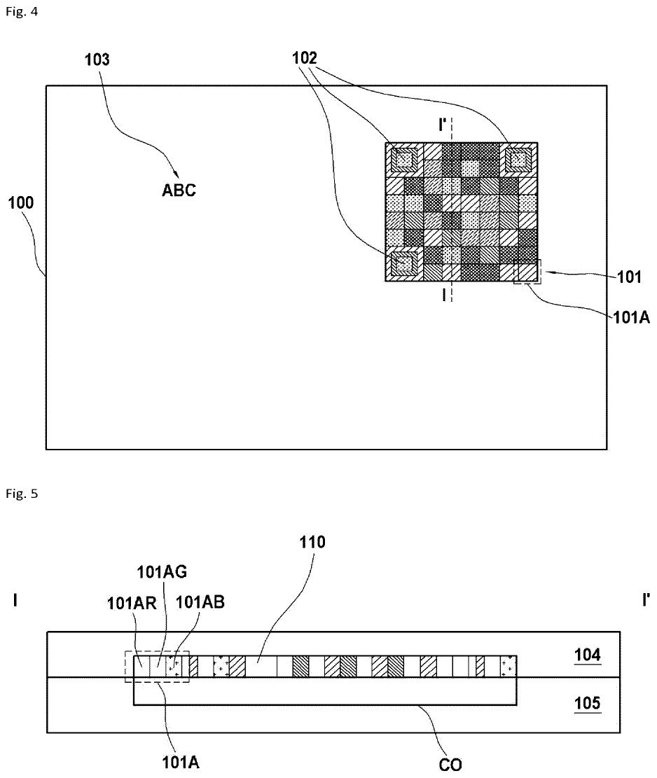

FIG. 4 shows the document 100 of FIGS. 1 to 3 after perforations have been formed in the basic pattern 101 and more precisely in the red, green and blue subpixels of the basic pattern.

The code elements of the basic pattern appear, when they observed in the given position, with a color that depends on the perforations. The color (or the perforations) of each code element is here associated with one information element, and hence the number of possible colors C corresponds to a number of bits n codable by each graphic-code element (n=ln(C)/ln(2)).

Here, a graphic code is obtained that is formed by the basic pattern of the graphic code, comprising perforations, with data coded taking into account the color specific to each graphic-code element of the graphic code observable after perforation in the given position.

By way of indication, using a code occupying an area of one square inch, and data coded by means of an alphabet of 64 characters, the following storage capacities may be obtained:

| | | |
|---|---|---|
| 2 colors | 1 | kilobyte |
| 8 colors | 4 | kilobyte |
| 16 colors | 5-6 | kilobytes |
| 64 colors | 8 | kilobyte |

The above values take into account the size occupied by the positioning marks, which limit the area allocatable to data.

FIG. 5 also shows a cross section cut along I-I′, in which the perforations 110 formed in the basic pattern may be seen.

The perforations may completely replace a subpixel, as is the case for the graphic-code element on the left of the figure, the red and green subpixels of which have been completely perforated (the code element has a blue observed color). The perforations may be partial, as may be seen for the rightmost code element of the figure, the red subpixel of which has a perforation that has destroyed half the subpixel (the code element has a purple observed color, the green subpixel having been destroyed).

The perforations may be produced by applying a laser beam the energy of which will destroy at least the reflective layer or even also the diffractive textures. The perforated parts appear black and do not contribute to the observed hue/color.

The use of a laser beam is advantageous since it allows documents to be personalized, i.e. formed with different perforations. For example, each document may comprise information coded in the graphic code that is specific to the user of the document (typically the holder of the document), for example biometric information such as an image of the user's face.

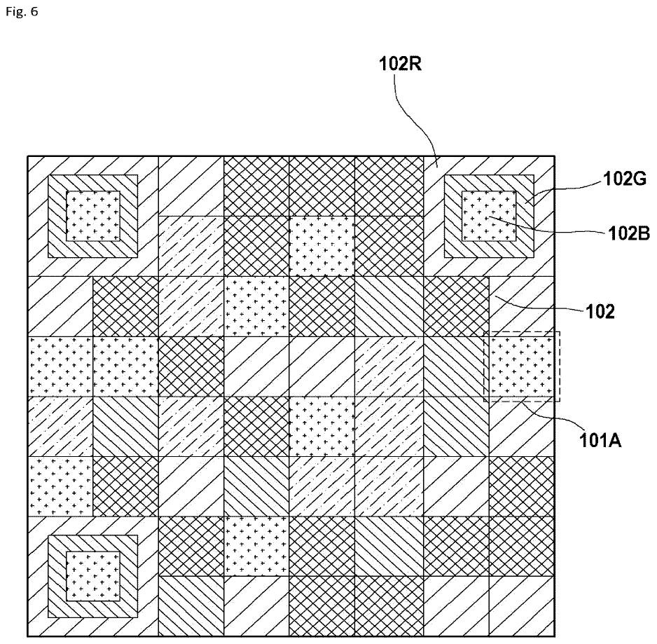

FIG. 6 shows in more detail the obtained graphic code. Although perforations have been formed, they may not be visible depending on the resolution used to read the graphic code. In fact, the observation of the graphic code may detect only a uniform color for each graphic-code element. This further results from the dimensions of the subpixels.

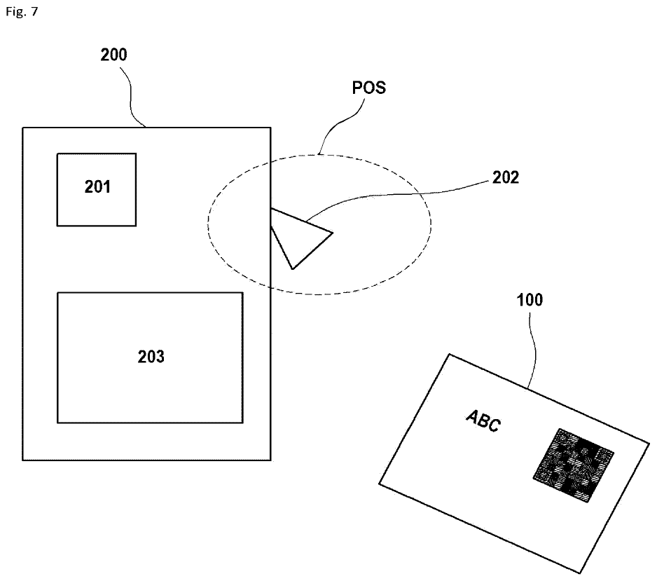

FIG. 7 shows a system 200 for reading information coded by the document 100 described above. The system 200 has a computer-system structure and comprises a processor 201.

The system also comprises a module 202 for observing the document in the given observation position (represented here by an ellipse POS). This module may be a digital camera, equipped or not with its own lighting means. Furthermore, the system may comprise means (not shown) for placing the document 100 in a chosen location related to the position of the module 202 (typically a document holder) and which means are also either equipped or not equipped with lighting means.

In the system 200, a non-volatile memory 203 has also been installed, which may comprise computer program instructions that, when they are executed by the processor 201, form the following two modules: a module for detecting positioning marks (visible in an image of the document acquired by the module 202), and a module for decoding information taking into account the colors observed in graphic-code elements (also visible in an image of the document acquired by the module 202). Advantageously, it is possible to add an authenticating module that takes into account the correctness of the variation in the colors in the vicinity of the position POS.

For example, the camera records a sequence of images (video) of the document presented at various observation angles, and the computer program is configured to select, from the sequence of acquired images, the image in which a region of the positioning mark has an expected color (for example, the color specific to the region visible in the given observation position).

The use of positioning marks having regions forming a color base makes it possible to implement a calibration phase in which the colors observed in the regions of the positioning mark are taken into account. This calibration may then be used to decode the graphic code.

By way of indication, the parameters corresponding to a minimum and greater noise robustness factor are presented below for code elements comprising a plurality of pixels (groups of three red-green-blue subpixels here). To obtain good noise resistance, it is preferable for a pixel of the camera to encompass two pixels (therefore six subpixels). For a camera capable of discerning details of X μm, it is preferable for the subpixels to be smaller than X/6 or even X/9. The minimum parameters are:

| Camera resolution | 800 dots per inch on the code | |
|---|---|---|
| | at the distance used with the | |
| | camera e.g. 30 cm | |
| Size of the pixels of the camera | 31.75 | μm |
| Minimum number of color pixels per | 2 | |
| camera pixel to achieve noise robustness | | |
| Minimum number of subpixels per | 6 | |
| code element | | |
| Maximum subpixel size | 5 | μm |

The parameters for good noise resistance are:

| Camera resolution | 800 dots per inch on the code | |
|---|---|---|
| | at the distance used with the | |
| | camera e.g. 30 cm | |
| Size of the pixels of the camera | 31.75 | μm |
| Minimum number of color pixels per | 3 | |
| camera pixel to achieve noise robustness | | |
| Minimum number of subpixels per | 9 | |
| code element | | |
| Maximum subpixel size | 4 | μm |

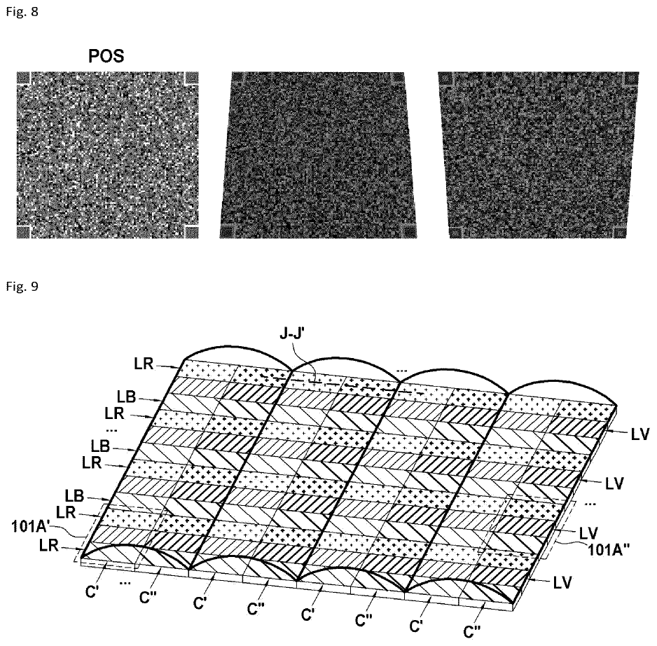

On the left of FIG. 8 a graphic code observed in the associated given observation position (POS) has been shown, red, green and blue positioning marks being visible and indicating that the graphic code may be decoded.

The middle graphic code and the right-hand graphic code have positioning marks that do not have the expected colors in the right regions. The colors of all the code elements are further different from the expected ones. For example, in the middle all the code elements may be a blue tint and on the right-hand side all the code elements may be a red tint: this makes it impossible to read the graphic code in any position other than the given observation position. Nonetheless, this property of color variation is fundamental to authentication of the code independently of its read-out.

In fact, according to one particular mode of implementation, at least one image of the image sequence in which a region of the positioning mark has a color other than the expected color is detected, with a view to deducing an authentication of the document therefrom (the document is considered to be valid, i.e. to have been issued by an authority such as a state).

For example, the positioning mark may be detected based on its shape (here the shape of its three regions) and a color that is not the expected color may be observed therein. This means that various observation angles lead to variations in color, and that the document indeed contains diffractive elements (it is not a copy printed with the expected colors).

The image in the center and the image on the right-hand side, which are both colored, clearly show that it is indeed a question of a graphic code using diffractive effects.

FIG. 9 shows the interleaving of two basic graphic-code patterns, allowing two graphic codes to be interleaved.

More precisely, the arrangement of two groups of code elements, code elements 101A′ of a first basic graphic-code pattern, and code elements 101A″ of a second basic graphic-code pattern, has been shown.

As may be seen in the figure, the two basic graphics-code patterns are interleaved. The code elements 101A′ of the first code are arranged in columns C′ that are separated by columns C″ in which the code elements 101A″ of the second basic graphic-code pattern are arranged.

Furthermore, the subpixels of the basic graphic-code pattern (in the columns C′) and the subpixels of the other basic graphic-code pattern (in the columns C″) capable of producing a diffractive effect of the same color are arranged in parallel rows in which the subpixels of the basic graphic-code pattern and the subpixels of the other basic graphic-code pattern alternate. These rows are referenced LR (rows of red subpixels), LV (rows of green subpixels), and LB (rows of blue subpixels).

An array of lenses has been shown in the figure, the lenses here extend in a direction perpendicular to the directions of the rows of subpixels.

The invention is not limited to these arrangements, it being possible to interleave basic patterns in other ways. For example, it is possible to interleave the basic patterns in such a way that there is an alternation between the graphic-code elements of each thereof in one direction (the horizontal direction in the figure).

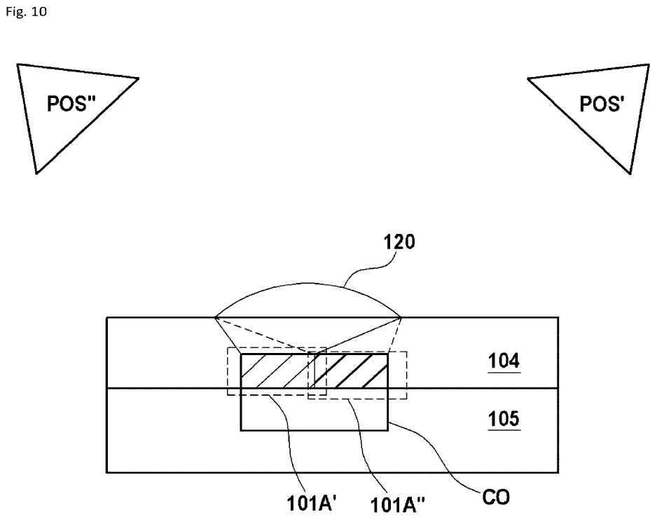

FIG. 10 shows the subpixels of the code elements of FIG. 10 in the cross-sectional plane J-J′. The code element 101A′ is analogous to the code element 101A described above, but it is observed in such a way that only one subpixel in the cross-sectional plane J-J′ is seen. Code element 101A″ is analogous to code element 101A described above.

The given observation position POS' shown in the figure is associated with the graphic-code element 101A′ and the given observation position POS″ shown in the figure is associated with the graphic-code element 101A″. Here the interleaving is in the horizontal direction in the figure, there being an alternation between the code elements of one pattern and of the other pattern.

To allow the two graphic codes to be interleaved, a constituent lens 120 of a lens array is employed. The lens 120 is associated with the two graphic-code elements 101A′ and 101A″ shown in the figure and extends as illustrated in FIG. 9. By means of the lens, light is focused on the subpixels of the graphic-code element 101A′ in the position POS' and it is focused on the subpixels of the graphic-code element 101A″ in the position POS″.

It will be noted that the lens 120 may be shared by all the code elements of the same column in the arrangement of FIG. 9.

Furthermore, each basic graphic-code pattern may have its own positioning mark.

An embodiment that is simple to produce is that in which rows of subpixels, for example RGB subpixels, are placed in a first direction and in which the cylindrical lenses are oriented in a second direction perpendicular to the first direction. This makes it easy to obtain constant diffracted colors when the lens array is rotated about an axis parallel to the second direction. The positioning marks may be common.

1. A security document comprising:
a basic pattern of a graphic code comprising graphic-code elements each having one or more subpixels, each subpixel being capable of producing a diffractive effect of a color specific to the subpixel when the subpixel is observed from a given observation position and under given lighting, and
a positioning mark, in addition to the elements of the graphic code, comprising a region capable of producing a diffractive effect of a color specific to the region when it is observed from the same given position and under the given lighting, and wherein the region of the positioning mark is capable of producing a diffractive effect of the same color as a subpixel of the basic graphic-code pattern from the same given observation position.

2. The document as claimed in claim 1, comprising one or more perforations of one or more subpixels of a graphic-code element so that the graphic-code element is capable of producing a diffractive effect of a color specific to the graphic-code element when the graphic-code element is observed from the given observation position, the color specific to the graphic-code element resulting from the diffractive effects of the subpixels of the graphic-code element and from the presence of the one or more perforations.

3. The document as claimed in claim 2, wherein data are coded in the graphic code formed by the basic pattern of the graphic code comprising one or more perforations, the coding of the data taking into account the color specific to each graphic-code element.

4. The document as claimed in claim 1, comprising another basic pattern of a graphic code,
the other basic pattern of a graphic code comprising graphic-code elements each having one or more subpixels, each subpixel being capable of producing a diffractive effect of a color specific to the subpixel when the subpixel is observed from another given observation position that differs from the given observation position,
another graphic-code positioning mark comprising a region capable of producing a diffractive effect of a color specific to the region when it is observed from the other given position,
the document further comprising a lens array the lenses of which are arranged so that, in the given observation position, light is focused on the subpixels of the basic graphic-code pattern, and in the other given observation position, light is focused on the subpixels of the other basic graphic-code pattern,
said basic graphic-code pattern and the other basic graphic-code pattern being interleaved.

5. The document as claimed in claim 4, the subpixels of the basic graphic-code pattern and the subpixels of the other basic graphic-code pattern capable of producing a diffractive effect of the same color are arranged in parallel rows in which the subpixels of the basic graphic-code pattern and the subpixels of the other basic graphic-code pattern alternate, and wherein the lens array comprises lenses extending in a direction perpendicular to those of the rows of subpixels.

6. The document as claimed in claim 1, wherein the area of the region of the positioning mark is larger than the area of each pixel of the basic graphic-code pattern, for example 10 times larger.

7. The document as claimed in claim 1, wherein the mark for positioning the graphic code comprises a plurality of regions, each region being capable of producing a diffractive effect of a color specific to the region when it is observed from the same given position (POS), the colors of the diffractive effects of each region being different and forming a color base.

8. The document as claimed in claim 7, wherein each region of the positioning mark is capable of producing a diffractive effect of the same color as a subpixel of the basic graphic-code pattern from the same given observation position.

9. A process for manufacturing a security document, wherein a basic pattern of a graphic code comprising graphic-code elements each having one or more subpixels is formed, each subpixel being capable of producing a diffractive effect of a color specific to the subpixel when the subpixel is observed from a given observation position and under given lighting, and
a mark for positioning the graphic code is formed, the positioning mark comprising a region capable of producing a diffractive effect of a color specific to the region when it is observed from the same given position and under given lighting.

10. The process as claimed in claim 9, wherein one or more subpixels of a graphic-code element are perforated so that the graphic-code element is capable of producing a diffractive effect of a color specific to the graphic-code element when the graphic-code element is observed from the given observation position, the color specific to the graphic-code element resulting from the diffractive effects of the subpixels of the graphic-code element and from the presence of the one or more perforations.

11. The process as claimed in claim 10, comprising obtaining data beforehand, and
coding the obtained data so as to deliver at least the positions of the one or more perforations prior to their perforation, so that the data are coded in the graphic code formed by the basic pattern of the graphic code comprising the one or more perforations, the coding of the data taking into account the color specific to each graphic-code element.

12. The process as claimed in claim 9, wherein another basic pattern of a graphic code is formed,
the other basic pattern of a graphic code comprising graphic-code elements each having one or more subpixels, each subpixel being capable of producing a diffractive effect of a color specific to the subpixel when the subpixel is observed from another given observation position that differs from the given observation position, and
another graphic-code positioning mark is formed, the graphic-code positioning mark comprising a region capable of producing a diffractive effect of a color specific to the region when it is observed from the other given position,
the process further comprising forming a lens array the lenses of which are arranged so that, in the given observation position, light is focused on the subpixels of the basic graphic-code pattern, and in the other given observation position, light is focused on the subpixels of the other basic graphic-code pattern,
said basic graphic-code pattern and the other basic graphic-code pattern being interleaved.

13. The process as claimed in claim 11, wherein the subpixels of the basic graphic-code pattern and the subpixels of the other basic graphic-code pattern capable of producing a diffractive effect of the same color are arranged in parallel rows in which the subpixels of the basic graphic-code pattern and the subpixels of the other basic graphic-code pattern alternate, and wherein the lens array comprises lenses extending in a direction perpendicular to those of the rows of subpixels.

14. A method for reading information coded by a document as claimed in at least claim 2, wherein the document is observed in the given observation position, the positioning mark is detected, and the information is decoded taking into account the colors observed in the graphic-code elements.

15. The method as claimed in claim 14, wherein a sequence of images of the document presented at various observation angles is obtained, and the image in which a region of the positioning mark has an expected color is selected from the sequence of obtained images, the selected image being an image in which the document is observed in the given observation position.

16. The method as claimed in claim 14, comprising detecting at least one image of the image sequence in which a region of the positioning mark has a color other than the expected color, with a view to deducing an authentication of the document therefrom.

17. The method as claimed in claim 14, the method comprising a calibration step in which the observed color of the region of the positioning mark is taken into account.

18. A system for reading from a document information coded by a document as claimed in claim 4, comprising a module for observing the document in the given observation position, a module for detecting the positioning mark, and a module for decoding the information taking into account the colors observed in the graphic-code elements.

19. The system as claimed in claim 18, wherein the system is configured to obtain a sequence of images of the document presented at various observation angles, and to select, from the sequence of obtained images, the image in which a region of the positioning mark has an expected color, the selected image being an image in which the document is observed in the given observation position.

20. The system as claimed in claim 18, configured to detect at least one image of the image sequence in which a region of the positioning mark has a color other than the expected color, with a view to deducing an authentication of the document therefrom.
